(19) United States
(12) Patent Application Publication
(10) Pub. No.: US 2016/0318179 A1
(43) Pub. Date: Nov. 3, 2016

(54) ROBOT SYSTEM

(71) Applicant: Seiko Epson Corporation, Tokyo (JP)

(72) Inventors: Daisuke KOMATSU, Suwa (JP); Kazushige AKAHA, Azumino (JP)

(21) Appl. No.: 15/134,479

(22) Filed: Apr. 21, 2016

(30) Foreign Application Priority Data
Apr. 28, 2015 (JP) 2015-091212

(51) Int. Cl. B25J 9/00; B25J 15/00

(52) U.S. Cl. CPC B25J 9/0018; B25J 15/0028

(57) ABSTRACT

A robot system includes a first robot having a robot arm including a first arm rotatable about a first rotation axis at the most proximal end, and a movable first cell. The first cell includes a bench portion, a pillar provided on the base portion, and an attachment portion provided on the pillar, on which the first robot is provided. The first rotation axis can be placed in a position shifted in a first direction from an intermediate position of a length of the bench portion in the first direction, and at least a part of the robot arm is movable to an outside of the bench portion in a plan view by moving in the first direction.

### BACKGROUND

1. Technical Field

The present invention relates to a robot system.

2. Related Art

In related art, robots with robot arms are known. In the robot arm, a plurality of arms (arm members) are coupled via joint parts and, as an end effector, e.g. a hand is attached to the arm on the most distal end side (on the most downstream side). The joint parts are driven by motors and the arms rotate by the driving of the joint parts. Then, for example, the robot grasps an object with the hand, moves the object to a predetermined location, and performs predetermined work such as assembly.

As an example of the robot, Patent Document 1 (JP-A-2010-137321) discloses a robot (machine tool) having a base (base part) and an arm part attached to the base. Further, Patent Document 1 discloses a cell (frame) provided to surround the robot. Furthermore, Patent Document 1 discloses that the base of the robot is attached to the ceiling of the cell. The robot described in Patent Document 1 can process work mounted on a pedestal located below.

However, the base of the robot is attached to the center part of the ceiling in Patent Document 1, and it is hard to extend the arm part to the outside of the cell. On this account, in the configuration described in Patent Document 1, operability when the robot operates outside of the cell is poor.

### SUMMARY

An advantage of some aspects of the invention is to provide a robot system that may improve operability of a first robot.

The invention can be implemented as the following forms or application examples.

### Application Example 1

A robot system according to this application example of the invention includes a first robot having a robot arm including a first arm rotatable about a first rotation axis at the most proximal end, and a movable first cell, wherein the first cell includes a bench portion, a pillar provided on the base portion, and an attachment portion provided on the pillar, on which the first robot is provided, the first rotation axis can be placed in a position shifted in a first direction from an intermediate position of a length of the bench portion in the first direction, and at least a part of the robot arm is movable to an outside of the bench portion in a plan view by moving in the first direction.

With this configuration, the first rotation axis is placed in the position shifted in the first direction from the intermediate position, and the operability of the first robot outside of the first cell may be improved.

### Application Example 2

In the robot system according to the application example of the invention, it is preferable that the first robot includes a second arm provided on the first arm rotatably about a second rotation axis in an axis direction different from an axis direction of the first rotation axis, a length of the first arm is longer than a length of the second arm, and the first arm and the second arm can overlap as seen from the second rotation axis.

With this configuration, the space for preventing interference of the robot 1 when a distal end of the second arm is moved to a position different by 180° about the first rotation axis may be made smaller. Accordingly, the first cell may be downsized and the installation space (installation location) in which the robot system is installed may be further reduced.

### Application Example 3

In the robot system according to the application example of the invention, it is preferable that the first cell includes a foot portion provided on the bench portion for installation of the first cell in a predetermined installation location, and the foot portion includes a projecting portion projecting from the bench portion in the first direction.

With this configuration, even when the first rotation axis is placed in the position shifted in the first direction and the center of gravity of the first robot is located in the first direction, the first cell may be supported more stably by the foot portion.

### Application Example 4

In the robot system according to the application example of the invention, it is preferable that a length of the projecting portion in the first direction is from 10 mm to 600 mm.

With this configuration, even when the first rotation axis is placed in the position shifted in the first direction and the center of gravity of the first robot is located in the first direction, the first cell may be supported more stably by the foot portion.

### Application Example 5

In the robot system according to the application example of the invention, it is preferable that the projecting portion is detachably attached to the bench portion.

With this configuration, for example, the foot portion having the length according to the amount of shift of the first rotation axis from the intermediate location is attached, and accordingly, even when the position of the first rotation axis is changed, the first cell may be supported more stably by the foot portion.

### Application Example 6

In the robot system according to the application example of the invention, it is preferable that at least a part of a carrying unit that carries parts is placed inside the first cell.

With this configuration, the total width of the first cell and the carrying unit may be made more compact. Accordingly, the space in which the first cell and the carrying unit are installed may be made smaller.

### Application Example 7

In the robot system according to the application example of the invention, it is preferable that the first cell includes a reinforcing portion provided on the pillar and the attachment portion.

With this configuration, for example, bending of the attachment portion downward may be suppressed. Accordingly, even when the first rotation axis is placed in the position shifted in the first direction and the center of gravity of the first robot is located in the first direction, the first robot may be stably supported by the attachment portion.

### Application Example 8

In the robot system according to the application example of the invention, it is preferable that the first rotation axis is located outside of the bench portion in the plan view.

With this configuration, the operability of the first robot outside of the first cell may be further improved.

### Application Example 9

In the robot system according to the application example of the invention, it is preferable that a connecting position of the pillar to the bench portion is provided in a position different from an end of the bench portion.

With this configuration, for example, the first rotation axis is placed in the position further shifted in the first direction from the intermediate position. Accordingly, the operability of the first robot outside of the first cell may be further improved.

### Application Example 10

In the robot system according to the application example of the invention, it is preferable that a position of the pillar with respect to the bench portion is changeable.

With this configuration, for example, the position of the pillar is changed according to work of the first robot, and thereby, the operability of the first robot may be further improved.

### Application Example 11

In the robot system according to the application example of the invention, a second cell is provided and it is preferable that the first cell and the second cell are coupled.

With this configuration, for example, a second robot is provided within the second cell, and accordingly, the first robot and the second robot may cooperatively perform work. Therefore, for example, the productivity of finally obtained products may be improved. Or, for example, the robot is not provided within the second cell and the second cell may be used for improvement of rigidity of the first cell.

### Application Example 12

In the robot system according to the application example of the invention, it is preferable that a second robot having a robot arm is provided in the second cell.

With this configuration, for example, the first robot and the second robot may cooperatively perform work. Accordingly, for example, the productivity of finally obtained products may be improved.

### Application Example 13

In the robot system according to the application example of the invention, it is preferable that at least a part of a carrying unit that carries parts is placed between the first cell and the second cell.

With this configuration, the total width of the first cell, the second cell, and the carrying unit may be made more compact. Accordingly, the space in which the first cell, the second cell, and the carrying unit are installed may be made smaller.

### Application Example 14

In the robot system according to the application example of the invention, a supporting portion provided movably with respect to the attachment portion and supporting the first robot is provided and it is preferable that the supporting portion is provided movably from the first cell to the second cell.

With this configuration, the first robot may move between the first cell and the second cell, and the first robot may perform work in a wider range.

### Application Example 15

A robot system according to this application example of the invention includes a first robot having a robot arm including a first arm rotatable about a first rotation axis at the most proximal end, and a movable first cell, wherein the first cell includes a bench portion, a pillar provided on the base portion, and an attachment portion provided on the pillar, on which the first robot is provided, an attachment position of the first robot with respect to the attachment portion can be placed in a position shifted in a first direction from an intermediate position of a length of the bench portion in the first direction, and at least a part of the robot arm is movable to an outside of the bench portion in a plan view by moving in the first direction.

With this configuration, the attachment position of the first robot is placed in the position shifted in the first direction from the intermediate position, and the operability of the first robot outside of the first cell may be improved.

### BRIEF DESCRIPTION OF THE DRAWINGS

The invention will be described with reference to the accompanying drawings, wherein like numbers reference like elements.

FIG. 1 is a perspective view showing the first embodiment of a robot system according to the invention.

FIG. 2 is a front view of a robot shown in FIG. 1.

FIG. 3 is a schematic diagram of the robot shown in FIG. 1.

FIG. 4 is a side view of the robot shown in FIG. 1.

FIG. 5 is a side view of the robot shown in FIG. 1.

FIGS. 6A to 6E are diagrams for explanation of actions of the robot shown in FIG. 1.

FIG. 7 is a side view of the robot system shown in FIG. 1.

FIGS. 8A to 8C are diagrams for explanation of actions of the robot shown in FIG. 1 at work.

FIGS. 9A and 9B are diagrams for explanation of actions of the robot shown in FIG. 1 at work.

FIG. 10 shows movement paths of a distal end of a robot arm of the robot shown in FIG. 1.

FIG. 11 shows the second embodiment of the robot system according to the invention.

FIG. 12 is a side view of the robot system shown in FIG. 11.

FIGS. 13A and 13B are side views showing the third embodiment of the robot system according to the invention.

FIGS. 14A and 14B show the fourth embodiment of the robot system according to the invention.

FIG. 15 is a side view showing the fifth embodiment of the robot system according to the invention.

FIG. 16 shows the sixth embodiment of the robot system according to the invention.

FIGS. 17A and 17B are side views of the robot system shown in FIG. 16.

FIG. 18 shows an example of a manufacturing line using the robot system according to the invention.

### DESCRIPTION OF EXEMPLARY EMBODIMENTS

Hereinafter, a robot system according to the invention will be explained in detail based on preferred embodiments shown in the accompanying drawings.

### First Embodiment

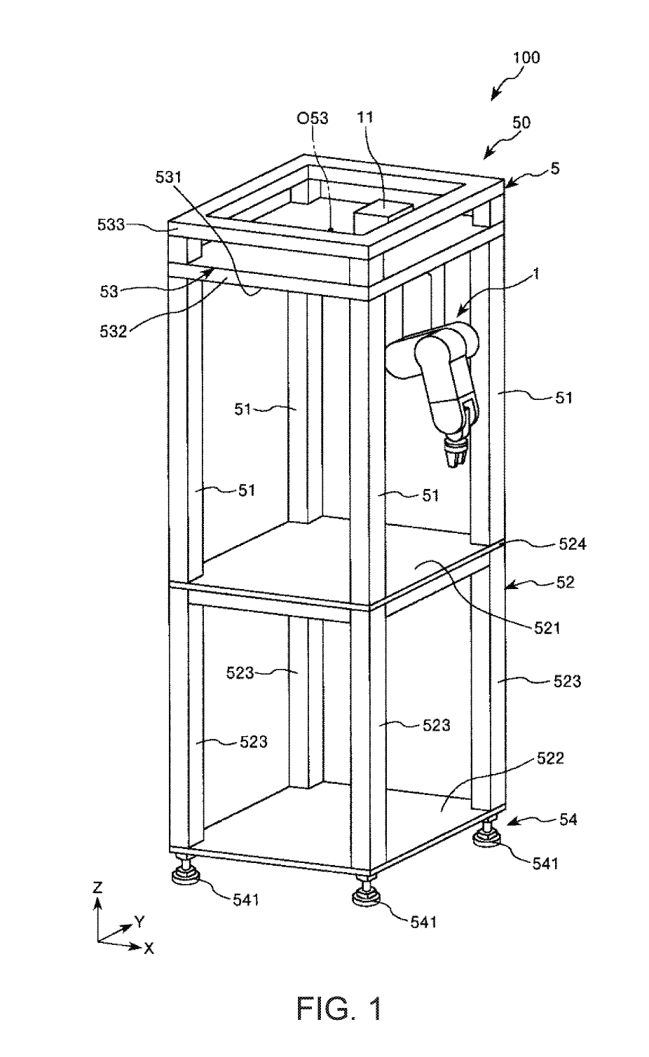

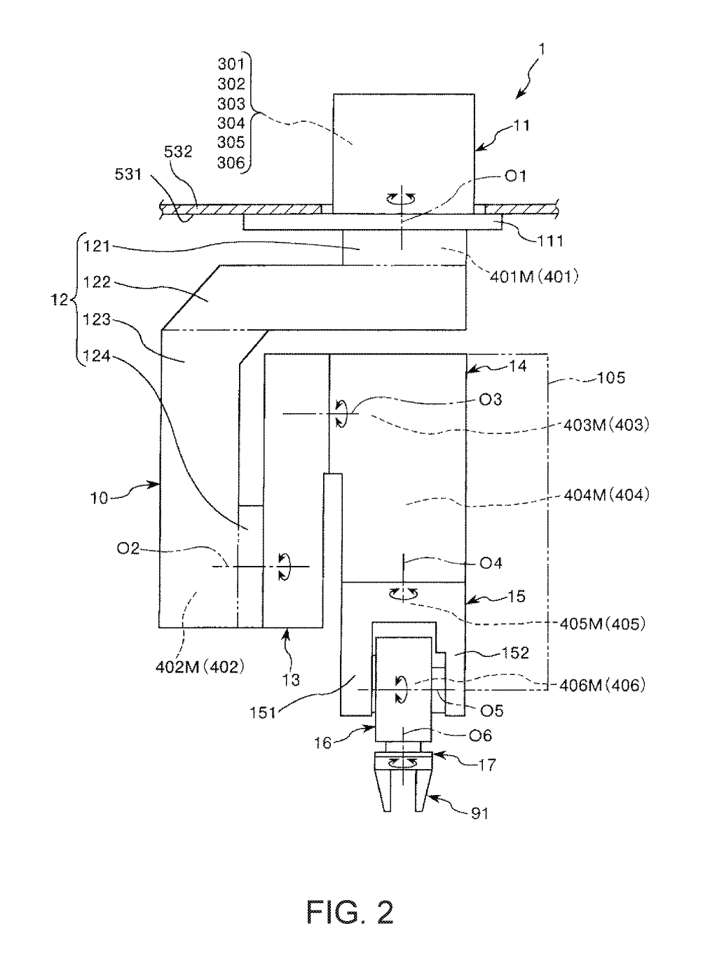

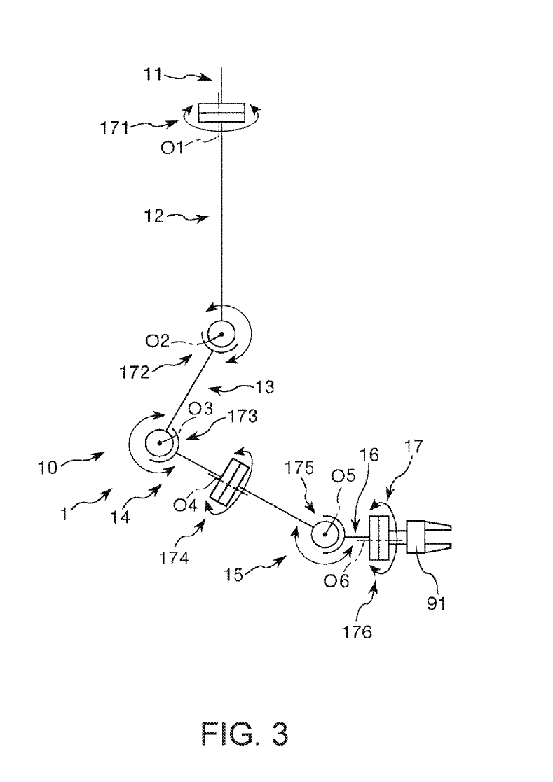

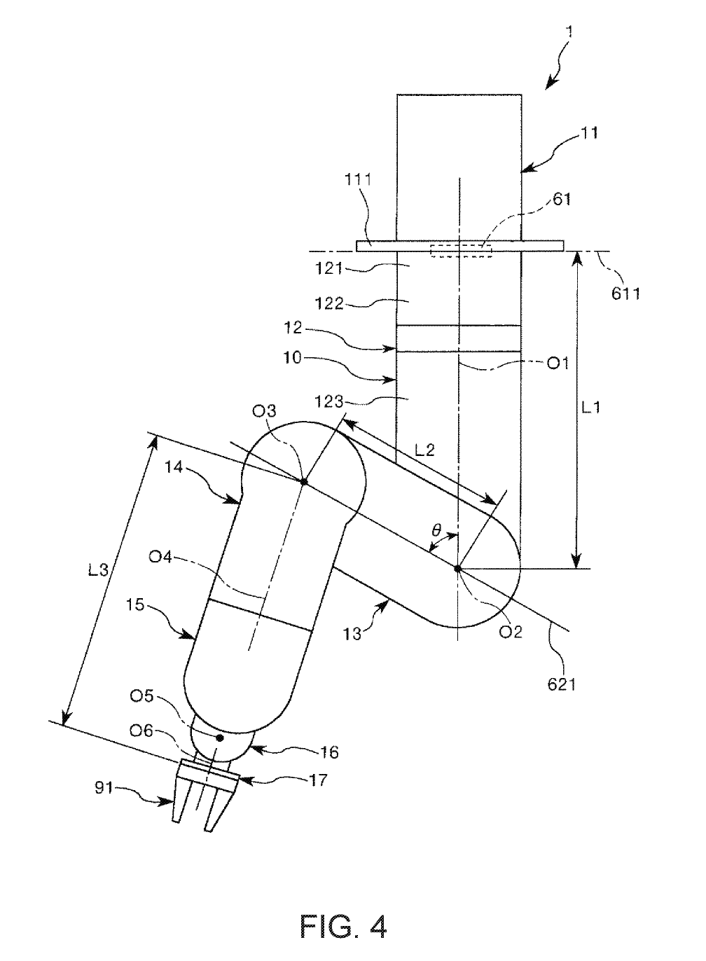

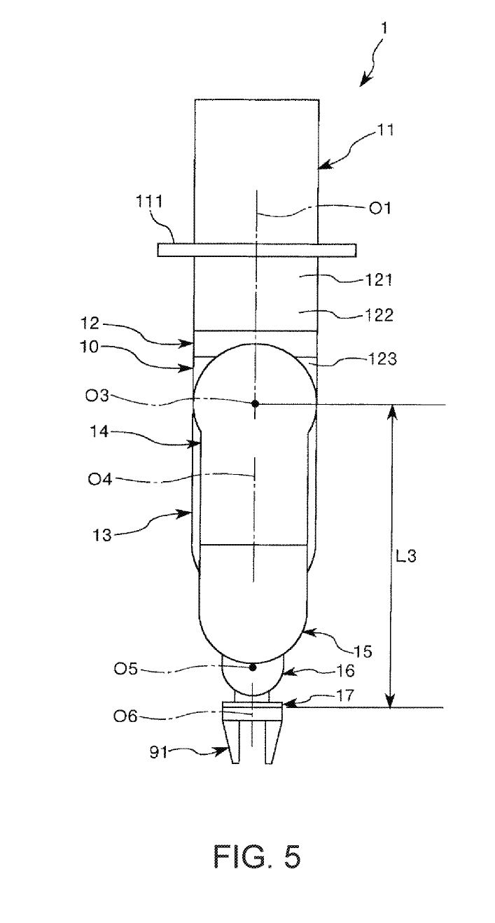

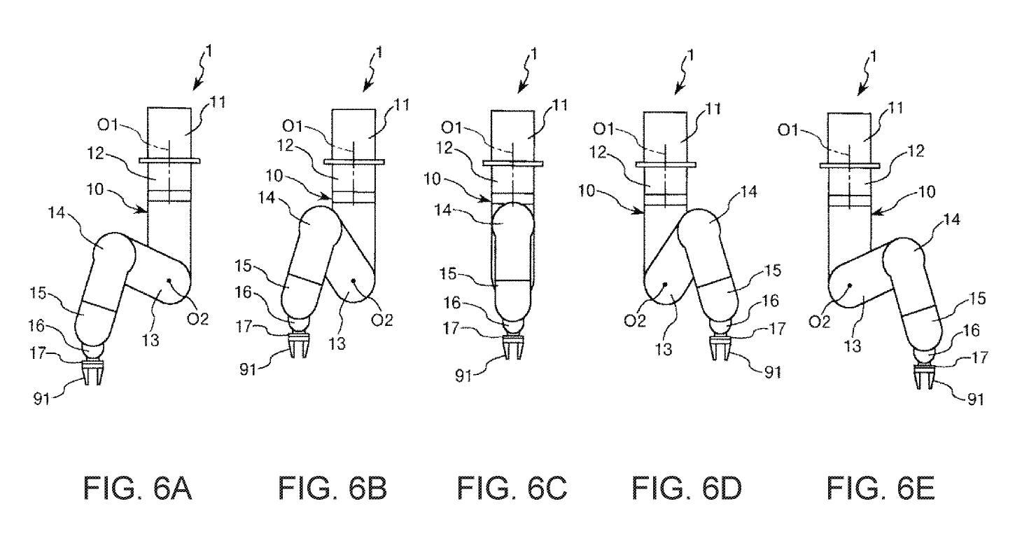

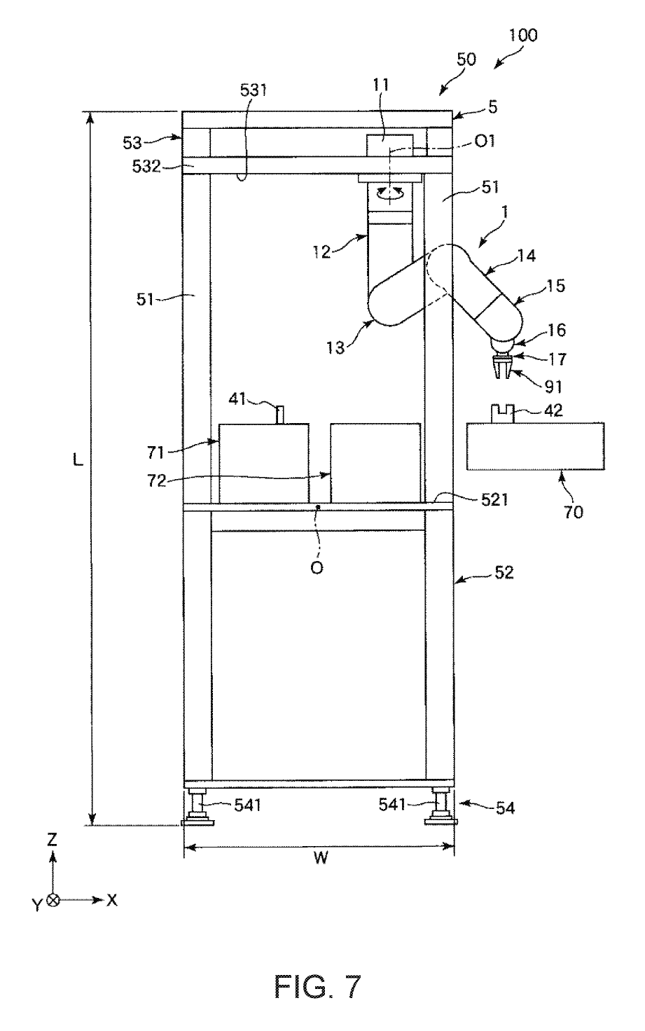

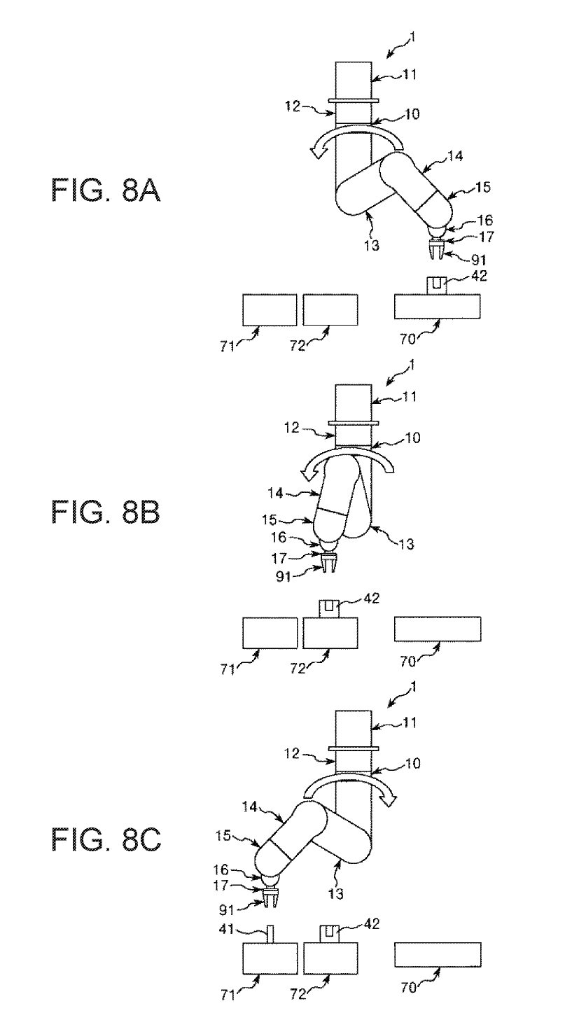

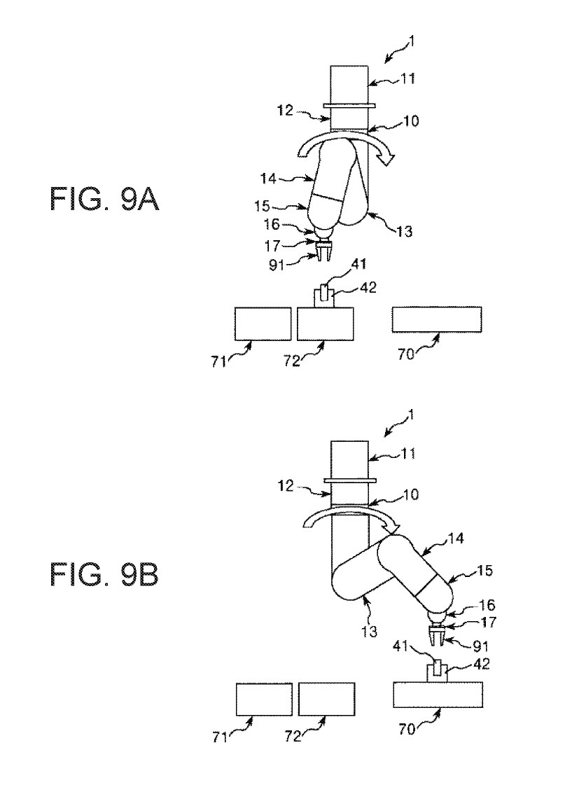

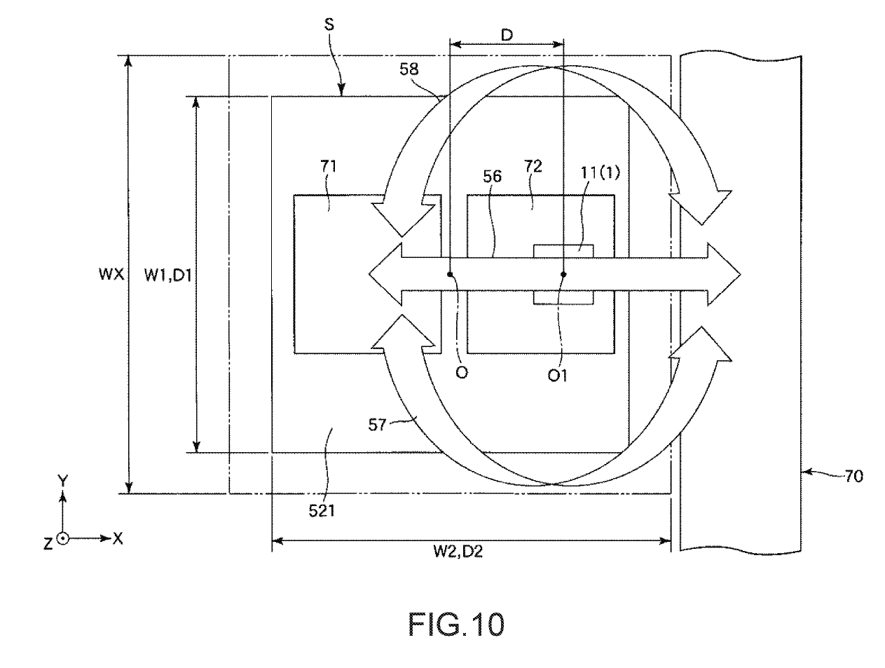

FIG. 1 is a perspective view showing the first embodiment of a robot system according to the invention. FIG. 2 is a front view of a robot shown in FIG. 1. FIG. 3 is a schematic diagram of the robot shown in FIG. 1. FIGS. 4 and 5 are respectively side views of the robot shown in FIG. 1. FIGS. 6A to 6E are diagrams for explanation of actions of the robot shown in FIG. 1. FIG. 7 is a side view of the robot system shown in FIG. 1. FIGS. 8A to 9B are respectively diagrams for explanation of actions of the robot shown in FIG. 1 at work. FIG. 10 shows movement paths of a distal end of a robot arm of the robot shown in FIG. 1.

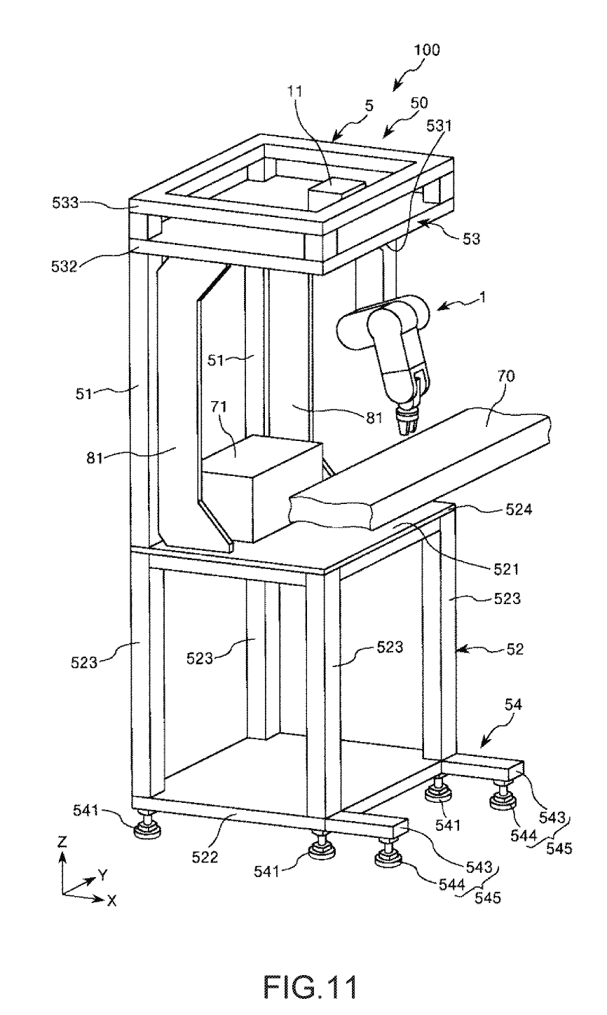

Hereinafter, for convenience of explanation, the upside in FIGS. 1 to 9B is referred to as “up” or “upper” and the downside is referred to as “low” or “lower” (the same applies to FIGS. 11 to 18, which will be described later). Further, the base side in FIGS. 1 to 9B is referred to as “proximal end” or “upstream” and the opposite side (the hand side) is referred to as “distal end” or “downstream” (the same applies to FIGS. 11 to 18 to be described later). Furthermore, the upward and downward directions in FIGS. 1 to 9B are referred to as “vertical directions” and the leftward and rightward directions are referred to as “horizontal directions” (the same applies to FIGS. 11 to 18 to be described later). In FIGS. 1, 7 and 10, for convenience of explanation, an X-axis, a Y-axis, a Z-axis are shown as three axes orthogonal to one another (the same applies to FIGS. 11 to 17 to be described later). Further, hereinafter, directions in parallel to the X-axis are also referred to as “X-axis directions”, directions in parallel to the Y-axis are also referred to as “Y-axis directions”, and directions in parallel to the Z-axis are also referred to as “Z-axis directions”. Furthermore, hereinafter, the tip end side of each arrow in the drawings is referred to as “+ (plus)” and the base end side is referred to as “− (minus)”. The direction in parallel to the +X-axis direction is also referred to as “+X-axis direction (first direction)”, the direction in parallel to the −X-axis direction is also referred to as “−X-axis direction”, the direction in parallel to the +Y-axis direction is also referred to as “+Y-axis direction”, the direction in parallel to the −Y-axis direction is also referred to as “−Y-axis direction”, the direction in parallel to the +Z-axis direction is also referred to as “+Z-axis direction”, and the direction in parallel to the −Z-axis direction is also referred to as “−Z-axis direction”.

A robot system 100 shown in FIG. 1 includes a robot cell 50 having a cell (first cell) 5 and a robot (first robot) 1.

For example, the robot system 100 may be used in a manufacturing process of manufacturing precision apparatuses such as wristwatches or the like. Further, the robot 1 may perform respective work of feeding, removing, carrying, and assembly of the precision apparatuses and parts forming the apparatuses.

Further, the robot system 100 includes a robot control apparatus (control unit) for controlling operation of the robot 1 (not shown). The robot control apparatus may be provided within the cell 5 or provided inside of the robot 1, or separated from the robot cell 50. The robot control apparatus may be formed using e.g. a personal computer (PC) containing a CPU (Central Processing Unit) or the like.

### Cell

As shown in FIG. 1, the cell 5 is a frame body surrounding the robot 1 and easily relocated. The cell 5 can be carried by a carrier apparatus such as a forklift (not shown). Further, the cell 5 may include wheels (not shown) to be movable by the wheels. Furthermore, the cell 5 may include a moving mechanism for moving the cell 5 (not shown) and a movement control unit for controlling driving of the moving mechanism (not shown) and may be formed to be self-propellant.

The cell 5 includes a foot portion 54 having four feet 541 for installation of the entire cell 5 in an installation space (installation location) of e.g. the ground (floor) or the like, a workbench (bench portion) 52 supported by the foot portion 54, four pillars 51 provided on the workbench 52, and a ceiling portion 53 provided on the upper ends of the four pillars 51.

The workbench 52 includes a bottom plate 522, four supporting legs 523 provided on the bottom plate 522, and a work plate 524 provided on the upper ends of the respective supporting legs 523. The upper surface of the work plate 524 is opposed to the ceiling portion 53, and serves as a work surface 521 on which the robot 1 may perform work of feeding, removing, or the like of the parts.

The four pillars 51 supporting the ceiling portion 53 are provided on the work surface 521. The four pillars 51 are respectively provided in the corners of the work surface 521.

The ceiling portion 53 is a member that supports the robot 1 and includes a top plate (attachment portion) 532 and an upper frame 533 provided above the top plate 532. The top plate 532 has four corners supported by the pillars 51. Further, the lower surface of the top plate 532 is a ceiling surface (attachment surface) 531, and a base 11 of the robot 1, which will be described later, is supported by the ceiling surface 531. Furthermore, the base 11 is attached at the X-axis side with respect to a center O53 of the ceiling surface 531 in a plan view (as seen from the vertical direction).

In the above description, the robot 1 is attached to the top plate 532, however, the robot 1 may be attached to e.g. the upper frame 533. In this case, the upper frame 533 may be regarded as the attachment portion and the lower surface or upper surface of the upper frame 533 may be regarded as the ceiling surface (attachment surface). Further, in the above description, the pillars 51 and the supporting legs 523 are separated, however, they may be integrated.

### Robot

As shown in FIG. 2, the robot 1 includes the base 11 and a robot arm 10. The robot arm 10 includes a first arm 12, a second arm 13, a third arm 14, a fourth arm 15, a fifth arm 16, and a sixth arm 17 (six arms), and a first drive source 401, a second drive source 402, a third drive source 403, a fourth drive source 404, a fifth drive source 405, and a sixth drive source 406 (six drive sources). For example, an end effector such as a hand 91 that grasps a precision apparatus such as a wristwatch, a part, or the like may be detachably attached to the distal end of the sixth arm 17.

The robot 1 is a vertical articulated (six-axis) robot in which the base 11, the first arm 12, the second arm 13, the third arm 14, the fourth arm 15, the fifth arm 16, and the sixth arm 17 are coupled in this order from the proximal end side toward the distal end side. As below, the first arm 12, the second arm 13, the third arm 14, the fourth arm 15, the fifth arm 16, and the sixth arm 17 will be respectively also referred to as “arm”. The first drive source 401, the second drive source 402, the third drive source 403, the fourth drive source 404, the fifth drive source 405, and the sixth drive source 406 will be respectively also referred to as “drive source (drive unit)”.

As shown in FIG. 2, the base 11 is a part fixed (member attached) to the ceiling surface 531. The fixing method is not particularly limited, but e.g. a fixing method using a plurality of bolts or the like may be employed. Note that, in the embodiment, a plate-like flange 111 provided in the lower part of the base 11 is attached to the ceiling surface 531, however, the attachment location of the base 11 to the ceiling surface 531 is not limited to that. For example, the location may be the upper surface of the base 11.

The base 11 may include a joint 171, which will be described later, or not (see FIG. 3).

As shown in FIG. 2, the robot arm 10 is rotatably supported with respect to the base 11 and the arms 12 to 17 are respectively supported to be independently displaceable with respect to the base 11.

The first arm 12 has a bending shape. The first arm 12 includes a first portion 121 connected to the base 11 and extending downward in the vertical direction from the base 11, a second portion 122 extending in the horizontal direction from the lower end of the first portion 121, a third portion 123 provided on an opposite end of the second portion 122 to the first portion 121 and extending in the vertical direction, and a fourth portion 124 extending in the horizontal direction from the distal end of the third portion 123. These first portion 121, second portion 122, third portion 123, and fourth portion 124 are integrally formed. Further, the second portion 122 and the third portion 123 are nearly orthogonal (cross) as seen from the near side of the paper surface of FIG. 2 (in a front view orthogonal to both a first rotation axis O1 and a second rotation axis O2, which will be described later).

The second arm 13 has a longitudinal shape and is connected to the distal end of the first arm 12 (the opposite end of the fourth portion 124 to the third portion 123).

The third arm 14 has a longitudinal shape and is connected to the opposite end of the second arm 13 to the end to which the first arm 12 is connected.

The fourth arm 15 is connected to the opposite end of the third arm 14 to the end to which the second arm 13 is connected. The fourth arm 15 includes a pair of supporting parts 151, 152 opposed to each other. The supporting parts 151, 152 are used for connection to the fifth arm 16.

The fifth arm 16 is located between the supporting parts 151, 152 and connected to the supporting parts 151, 152, and thereby, coupled to the fourth arm 15. Note that the structure of the fourth arm 15 is not limited to that. For example, only one supporting part may be provided (cantilever).

The sixth arm 17 has a flat plate shape and is connected to the distal end of the fifth arm 16. Further, the hand 91 is detachably attached to the distal end of the sixth arm 17 (the opposite end to the fifth arm 16). The hand 91 includes, but not particularly limited to, e.g. a configuration having a plurality of finger portions (fingers).

Each of the exteriors of the above described respective arms 12 to 17 may be formed by a single member or a plurality of members.

Next, referring to FIGS. 2 and 3, the drive sources 401 to 406 with driving of these arms 12 to 17 will be explained. FIG. 3 shows the schematic view of the robot 1 as seen from the right side in FIG. 2. Further, FIG. 3 shows a state in which the arms 13 to 17 have been rotated from the state shown in FIG. 2.

As shown in FIG. 3, the base 11 and the first arm 12 are coupled via the joint 171. The joint 171 includes a mechanism that rotatably supports the first arm 12 coupled to the base 11 with respect to the base 11. Thereby, the first arm 12 is rotatable around the first rotation axis O1 in parallel to the vertical direction (about the first rotation axis O1) with respect to the base 11. The first rotation axis O1 is aligned with a normal of the ceiling surface 531 to which the base 11 is attached. Further, the first rotation axis O1 is a rotation axis on the most upstream side of the robot 1. The rotation about the first rotation axis O1 is performed by driving of the first drive source 401 having a motor 401M. Further, the first drive source 401 is driven by the motor 401M and a cable (not shown), and the motor 401M is controlled by a robot control apparatus via a motor driver 301 electrically connected thereto. Note that the first drive source 401 may be adapted to transmit the drive power from the motor 401M by a reducer (not shown) provided with the motor 401M, or the reducer may be omitted.

The first arm 12 and the second arm 13 are coupled via a joint 172. The joint 172 includes a mechanism that rotatably supports one of the first arm 12 and the second arm 13 coupled to each other with respect to the other. Thereby, the second arm 13 is rotatable around the second rotation axis O2 in parallel to the horizontal direction (about the second rotation axis O2) with respect to the first arm 12. The second rotation axis O2 is orthogonal to the first rotation axis O1. The rotation about the second rotation axis O2 is performed by driving of the second drive source 402 having a motor 402M. Further, the second drive source 402 is driven by the motor 402M and a cable (not shown), and the motor 402M is controlled by the robot control apparatus via a motor driver 302 electrically connected thereto. Note that the second drive source 402 may be adapted to transmit the drive power from the motor 402M by a reducer (not shown) provided with the motor 402M, or the reducer may be omitted. The second rotation axis O2 may be parallel to the axis orthogonal to the first rotation axis O1, or the second rotation axis O2 may be different in axis direction from the first rotation axis O1, not orthogonal thereto.

The second arm 13 and the third arm 14 are coupled via a joint 173. The joint 173 includes a mechanism that rotatably supports one of the second arm 13 and the third arm 14 coupled to each other with respect to the other. Thereby, the third arm 14 is rotatable around a third rotation axis O3 in parallel to the horizontal direction (about the third rotation axis O3) with respect to the second arm 13. The third rotation axis O3 is parallel to the second rotation axis O2. The rotation about the third rotation axis O3 is performed by driving of the third drive source 403. Further, the third drive source 403 is driven by a motor 403M and a cable (not shown), and the motor 403M is controlled by the robot control apparatus via a motor driver 303 electrically connected thereto. Note that the third drive source 403 may be adapted to transmit the drive power from the motor 403M by a reducer (not shown) provided with the motor 403M, or the reducer may be omitted.

The third arm 14 and the fourth arm 15 are coupled via a joint 174. The joint 174 includes a mechanism that rotatably supports one of the third arm 14 and the fourth arm 15 coupled to each other with respect to the other. Thereby, the fourth arm 15 is rotatable around a fourth rotation axis O4 in parallel to the center axis direction of the third arm 14 (about the fourth rotation axis O4) with respect to the third arm 14. The fourth rotation axis O4 is orthogonal to the third rotation axis O3. The rotation about the fourth rotation axis O4 is performed by driving of the fourth drive source 404. Further, the fourth drive source 404 is driven by a motor 404M and a cable (not shown), and the motor 404M is controlled by the robot control apparatus via a motor driver 304 electrically connected thereto. Note that the fourth drive source 404 may be adapted to transmit the drive power from the motor 404M by a reducer (not shown) provided with the motor 404M, or the reducer may be omitted. The fourth rotation axis O4 may be parallel to the axis orthogonal to the third rotation axis O3, or the fourth rotation axis O4 may be different in axis direction from the third rotation axis O3, not orthogonal thereto.

The fourth arm 15 and the fifth arm 16 are coupled via a joint 175. The joint 175 includes a mechanism that rotatably supports one of the fourth arm 15 and the fifth arm 16 coupled to each other with respect to the other. Thereby, the fifth arm 16 is rotatable around a fifth rotation axis O5 orthogonal to the center axis direction of the fourth arm 15 (about the fifth rotation axis O5) with respect to the fourth arm 15. The fifth rotation axis O5 is orthogonal to the fourth rotation axis O4. The rotation about the fifth rotation axis O5 is performed by driving of the fifth drive source 405. Further, the fifth drive source 405 is driven by a motor 405M and a cable (not shown), and the motor 405M is controlled by the robot control apparatus via a motor driver 305 electrically connected thereto. Note that the fifth drive source 405 may be adapted to transmit the drive power from the motor 405M by a reducer (not shown) provided with the motor 405M, or the reducer may be omitted. The fifth rotation axis O5 may be parallel to the axis orthogonal to the fourth rotation axis O4, or the fifth rotation axis O5 may be different in axis direction from the fourth rotation axis O4, not orthogonal thereto.

The fifth arm 16 and the sixth arm 17 are coupled via a joint 176. The joint 176 includes a mechanism that rotatably supports one of the fifth arm 16 and the sixth arm 17 coupled to each other with respect to the other. Thereby, the sixth arm 17 is rotatable around the sixth rotation axis O6 (about the sixth rotation axis O6) with respect to the fifth arm 16. The sixth rotation axis O6 is orthogonal to the fifth rotation axis O5. The rotation about the sixth rotation axis O6 is performed by driving of the sixth drive source 406. Further, the sixth drive source 406 is driven by a motor 406M and a cable (not shown), and the motor 406M is controlled by the robot control apparatus via a motor driver 306 electrically connected thereto. Note that the sixth drive source 406 may be adapted to transmit the drive power from the motor 406M by a reducer (not shown) provided with the motor 406M, or the reducer may be omitted. The fifth rotation axis O5 may be parallel to the axis orthogonal to the fourth rotation axis O4, the sixth rotation axis O6 may be parallel to the axis orthogonal to the fifth rotation axis O5, or the sixth rotation axis O6 may be different in axis direction from the fifth rotation axis O5, not orthogonal thereto.

The robot 1 driving in the above described manner controls the actions of the arms 12 to 17 etc. while grasping a precision apparatus, a part, or the like with the hand 91 connected to the distal end of the sixth arm 17, and thereby, may perform respective work of carrying the precision apparatus, the part, or the like. The driving of the hand 91 is controlled by the robot control apparatus.

In the illustrated configuration, the motor drivers 301 to 306 are provided in the base 11, however, not limited to that. For example, the motor drivers may be provided in the robot control apparatus.

As above, the configuration of the robot 1 is briefly explained.

Next, referring to FIGS. 4, 5, and 6A to 6E, the relationships among the arms 12 to 17 will be explained, and the explanation will be made from various viewpoints while the expressions etc. are changed. Further, the third arm 14, the fourth arm 15, the fifth arm 16, and the sixth arm 17 are considered in a condition that they are stretched straight, in other words, in a condition that the fourth rotation axis O4 and the sixth rotation axis O6 are aligned or in parallel as shown in FIGS. 4 and 5.

First, as shown in FIG. 4, a length L1 of the first arm 12 is set to be longer than a length L2 of the second arm 13.

Here, the length L1 of the first arm 12 is a distance between the second rotation axis O2 and a center line 611 extending in the leftward and rightward directions in FIG. 4 of a bearing part 61 (a member of the joint 171) that rotatably supports the first arm 12 as seen from the axis direction of the second rotation axis O2. Further, the length L2 of the second arm 13 is a distance between the second rotation axis O2 and the third rotation axis O3 as seen from the axis direction of the second rotation axis O2.

Further, as shown in FIG. 5, the robot 1 is adapted so that an angle θ formed between the first arm 12 and the second arm 13 may be 0° as seen from the axis direction of the second rotation axis O2. That is, the robot 1 is adapted so that the first arm 12 and the second arm 13 may overlap as seen from the axis direction of the second rotation axis O2. The second arm 13 is adapted so that, when the angle θ is 0°, i.e., the first arm 12 and the second arm 13 overlap as seen from the axis direction of the second rotation axis O2, the second arm 13 may not interfere with the second portion 122 of the first arm 12 and the ceiling surface 531.

Here, the angle θ formed by the first arm 12 and the second arm 13 is an angle formed by a straight line passing through the second rotation axis O2 and the third rotation axis O3 (a center axis of the second arm 13 as seen from the axis direction of the second rotation axis O2) 621 and the first rotation axis O1 as seen from the axis direction of the second rotation axis O2 (see FIG. 4).

Furthermore, as shown in FIG. 5, the robot 1 is adapted so that the second arm 13 and the third arm 14 may overlap as seen from the axis direction of the second rotation axis O2. That is, the robot 1 is adapted so that the first arm 12, the second arm 13, and the third arm 14 may overlap at the same time as seen from the axis direction of the second rotation axis O2.

A total length L3 of the third arm 14, the fourth arm 15, the fifth arm 16, and the sixth arm 17 is set to be longer than the length L2 of the second arm 13. Thereby, as seen from the axis direction of the second rotation axis O2, when the second arm 13 and the third arm 14 are overlapped, the distal end of the robot arm 10, i.e., the distal end of the sixth arm 17 may be protruded from the second arm 13. Therefore, the hand 91 may be prevented from interfering with the first arm 12 and the second arm 13.

Here, the total length L3 of the third arm 14, the fourth arm 15, the fifth arm 16, and the sixth arm 17 is a distance between the third rotation axis O3 and the distal end of the sixth arm 17 as seen from the axis direction of the second rotation axis O2 (see FIG. 5). In this case, regarding the third arm. 14, the fourth arm 15, the fifth arm 16, and the sixth arm 17, the fourth rotation axis O4 and the sixth rotation axis O6 are aligned or in parallel as shown in FIG. 5.

In the robot 1, as shown in FIGS. 6A, 6B, 6C, 6D, 6E, by rotation of the second arm 13 without rotation of the first arm 12, the distal end of the second arm 13 may be moved to a position different by 180° about the first rotation axis O1 through the state in which the angle θ is 0° as seen from the axis direction of the second rotation axis O2. Accordingly, the distal end of the robot arm 10 may be moved from a position (first position) shown in FIG. 6A to a position (second position) shown in FIG. 6E different by 180° about the first rotation axis O1 from the position shown in FIG. 6A through the state in which the first arm 12 and the second arm 13 overlap as shown in FIG. 6C. Thereby, the distal end of the robot arm 10 and the hand 91 may be linearly moved in the plan view (as seen from the axis direction of the first rotation axis O1). Note that, in the movement, the third arm 14, the fourth arm 15, the fifth arm 16, and the sixth arm 17 are respectively rotated as appropriate.

As shown in FIGS. 6A to 6E, the robot 1 can perform the action of moving the distal end of the second arm 13 to the position different by 180° about the first rotation axis O1 without rotating the first arm 12, and the robot 1 may move the hand 91 with little change of the height (the position in the vertical direction) of the distal end of the robot arm 10 (at the nearly constant height).

Further, in the robot 1 having the above described configuration, a region (part) 105 of the third arm 14 and the fourth arm 15 surrounded by a dashed-two dotted line on the right in FIG. 2 is a region (part) in which the robot 1 does not interfere or hardly interferes with the robot 1 itself or another member. Accordingly, in the case where a predetermined member is mounted on the region 105, the member hardly interferes with the robot 1 or a peripheral apparatus or the like. Therefore, in the robot 1, the predetermined member can be mounted on the region 105. Particularly, in the case where the predetermined member is mounted on the region of the third arm 14 on the right in FIG. 2 of the region 105, the probability that the member interferes with a peripheral apparatus provided on the workbench 52 (not shown) is lower and the configuration is more effective.

Objects that can be mounted on the region 105 include e.g. a control apparatus for controlling driving of a sensor of a hand or a hand camera, a solenoid valve for a suction mechanism, etc.

As a specific example, for example, when a suction mechanism is provided in the hand, if a solenoid valve or the like is provided in the region 105, the solenoid valve does not cause an obstruction when the robot 1 is driven. Thus, the region 105 is highly convenient.

Next, referring to FIGS. 7, 8A to 8C, 9A and 9B, and 10, examples of work performed by the robot 1 and actions of the robot 1 at the work will be explained. Here, the work of the robot 1 of placing apart 42 carried by a conveyer (carrying unit) 70 on a part processing portion 72, incorporating a part 41 placed on a part supply portion 71 in the part 42 on the part processing portion 72, and then, placing the part 42 on the conveyer 70 again is explained. Note that, though not shown in FIG. 1, the part supply portion 71 and the part processing portion 72 are provided on the work surface 521 as shown in FIG. 7. Further, in FIGS. 7, 8A to 8C, 9A and 9B, and 10, the part supply portion 71, the part processing portion 72, and the conveyer 70 are schematically shown (the same applies to FIGS. 11 to 18 to be described later).

First, as shown in FIG. 8A, the robot 1 drives the robot arm 10 to move the hand 91 onto the conveyer 70. Then, the robot 1 grasps the part 42 placed on the conveyer 70 with the hand 91.

Then, as shown in FIG. 8B, the robot 1 moves the hand 91 to a position different by 180° about the first rotation axis O1 through the state in which the angle θ formed by the first arm 12 and the second arm 13 is 0° as seen from the axis direction of the second rotation axis O2 by rotating the second arm 13 and the third arm 14 without rotating the first arm 12. Then, the part 42 is placed on the part processing portion 72 by the hand 91. In this regard, as fine adjustment, an arbitrary arm of the first arm 12, the fourth arm 15, the fifth arm 16, and the sixth arm 17 may be rotated.

Then, as shown in FIG. 8C, the robot 1 rotates the second arm 13 and the third arm 14 to move the hand 91 onto the part supply portion 71. Then, the robot 1 grasps the part 41 placed on the part supply portion 71 by the hand 91. In this regard, as fine adjustment, an arbitrary arm of the first arm 12, the fourth arm 15, the fifth arm 16, and the sixth arm 17 may be rotated.

Then, as shown in FIG. 9A, the robot 1 rotates the second arm 13 and the third arm 14 to move the hand 91 onto the part processing portion 72. Then, the robot 1 incorporates the part 41 in the part 42 placed on the part processing portion 72 by the hand 91. In this regard, as fine adjustment, an arbitrary arm of the first arm 12, the fourth arm 15, the fifth arm 16, and the sixth arm 17 may be rotated.

Then, as shown in FIG. 9B, the hand 91 is moved to a position different by 180° about the first rotation axis O1 through the state in which the angle θ formed by the first arm 12 and the second arm 13 is 0° as seen from the axis direction of the second rotation axis O2 by rotation of the second arm 13 and the third arm 14 without rotation of the first arm 12. Thereby, the hand 91 is moved onto the conveyer 70. Then, the robot 1 places the part 42 on the conveyer 70 by the hand 91. In this regard, as fine adjustment, an arbitrary arm of the first arm. 12, the fourth arm 15, the fifth arm 16, and the sixth arm 17 may be rotated.

In this manner, the work of carrying the parts 41, 42 and incorporating (processing) the part 41 in the part 42 may be performed by the robot 1. Further, the robot 1 may repeat the work.

Here, as shown in FIG. 7, the attachment position of the robot 1 to the ceiling surface 531 is located at the +X-axis side with respect to a center O of the work surface 521 in the plan view (as seen from the vertical direction). That is, as shown in FIG. 10, the first rotation axis O1 of the robot 1 is located at the +X-axis side with respect to the center O in the plan view. Note that the center O is an intersection between a line segment passing through an intermediate position of a width (length) D2 of the work surface 521 in the X-axis direction and a line segment passing through an intermediate position of a width (length) D1 of the work surface 521 in the Y-axis direction. Further, the conveyer 70 is provided at the +X-axis side with respect to the cell 5 in the plan view.

The robot 1 is provided as described above, and thereby, in addition to the work in the part supply portion 71 and the part processing portion 72 within the cell 5, the work on the conveyer 70 outside of the cell 5 may be easily performed. Therefore, the operability of the robot 1 may be improved.

Further, a separation distance D between the first rotation axis O1 and the center O in the plan view and the width D2 preferably satisfy a relationship of 0.1≦D/D2<0.5, more preferably satisfy a relationship of 0.15≦D/D2≦0.45, and even preferably satisfy a relationship of 0.2≦D/D2≦0.4. Thereby, the robot 1 may be supported more stably by the ceiling portion 53 and the operability of the robot 1 outside of the cell 5 may be further improved.

Note that, in the embodiment, the first rotation axis O1 of the robot 1 is provided on the line segment passing through the intermediate position of the width D1 of the work surface 521 in the Y-axis direction in the plan view, however, the first rotation axis O1 may be shifted toward the +Y-axis side or the −Y-axis side from the line segment.

Further, by the driving of the robot arm 10, as shown in FIG. 10, the robot 1 may perform the actions of moving the hand 91 as shown by an arrow 56 without actions of moving the hand 91 as shown by arrows 57, 58 in the plan view. That is, the robot 1 may perform actions of moving the hand 91 (the distal end of the robot arm 10) on a straight line in the plan view (as seen from the axis direction of the first rotation axis O1). Thereby, the space for preventing interference of the robot 1 may be made smaller, and the cell 5 may be downsized. Accordingly, the area of the installation space for installation of the robot cell 50 (installation area), i.e., the area S of the cell 5 in the plan view may be made smaller than that of related art.

Specifically, the area S is preferably less than 637,500 mm², more preferably 500,000 mm² or less, even more preferably 400,000 mm² or less, and particularly preferably 360,000 mm² or less. As described above, the robot 1 may perform those actions, and thus, even in the area S, the robot arm 10 may be driven not to interfere with the cell 5.

The area S equal to or less than 400,000 mm² is nearly equal to or less than the size of the work area in which a human (worker) works. Accordingly, when the area S is less than the upper limit, for example, replacement of a human by the robot cell 50 may be easily performed. Note that the reverse change to the above described change, i.e., replacement of the robot cell 50 by a human may be easily made. Therefore, for example, in the case where the manufacturing line is changed by exchange of the human for the robot 50, the change may be easily performed. Further, the area S is preferably 10,000 mm² or more. Thereby, the maintenance inside of the robot cell 50 may be easily performed.

Since the area S may be made smaller, as shown in FIG. 10, a width W1 of the cell 5 in the Y-axis direction may be made smaller than a width WX of related art, specifically, e.g. 80% of the width WX of related art or less.

Specifically, the width W1 is preferably less than 850 mm, more preferably less than 750 mm, and even more preferably 650 mm or less (see FIG. 10). Thereby, the same advantages as the above described advantages may be sufficiently exerted. Note that the width W1 is an average width of the cells 5. The width W1 is preferably 100 mm or more. Thereby, the maintenance inside of the robot cell 50 may be easily performed.

Note that, in the embodiment, the cell 5 includes a square shape in the plan view. Accordingly, in the embodiment, the width (depth) W1 of the cell 5 in the Y-axis directions (upward and downward directions in FIG. 10) and a width (lateral width) W2 of the cell 5 in the X-axis directions (leftward and rightward directions in FIG. 10) are the same. Or, these width W1 and W2 may be different.

Further, as described above, the robot 1 may move the hand 91 with little change of the height of the distal end of the robot arm 10 (at the nearly constant height). Accordingly, the height of the cell 5 (the length in the vertical direction) L may be made lower than the height in related art (see FIG. 7). Specifically, the height L of the cell 5 may be reduced to e.g. 80% of the height in related art or less. Thereby, the ceiling surface 531 may be made lower and the position of the center of gravity of the robot 1 may be made lower. Accordingly, the vibration generated by the actions of the robot 1 may be reduced.

Specifically, the height L is preferably 1,700 mm or less, and more preferably from 1,000 mm to 1,650 mm. When the height is equal to or less than the upper limit, the influence of the vibration when the robot 1 acts within the cell 5 may be further suppressed. Or, when the height is equal to or more than the lower limit, the interference of the robot 1 with e.g. the work surface 521 may be avoided. Note that the height L is an average height of the cell 5 (including the foot portion 54).

If the above described action of moving the hand 91 (the distal end of the robot arm 10) of the robot 1 to the position different by 180° about the first rotation axis O1 is executed by simple rotation of the first arm 12 about the first rotation axis O1 like the robot of related art, the robot 1 may interfere with the cell 5 and the peripheral apparatus, and it is necessary to teach the robot 1 an evacuation point for avoiding the interference. For example, if the robot 1 interferes with the pillar 51 of the cell 5 or the like when only the first arm. 12 is rotated to 90° about the first rotation axis O1, it is necessary to teach the robot 1 an evacuation point for avoiding the interference with the pillar 51 or the like by rotation of another arm. Similarly, if the robot 1 also interferes with the peripheral apparatus, it is necessary to teach the robot 1 another evacuation point for avoiding the interference with the peripheral apparatus. As described above, in the robot of related art, it is necessary to teach many evacuation points and, in the case of a small cell, particularly, a huge number of evacuation points are necessary and a lot of efforts and a long time are required for teaching.

On the other hand, in the robot 1, when the actions of moving the hand 91 to the position different by 180° about the first rotation axis O1 is executed, there are very few regions and portions with which the robot may interfere, and the number of evacuation points to be taught may be reduced and the efforts and the time required for teaching may be reduced. That is, in the robot 1, the number of evacuation points to be taught becomes e.g. about one third of that of the robot of related art, and the teaching dramatically becomes easier.

### Second Embodiment

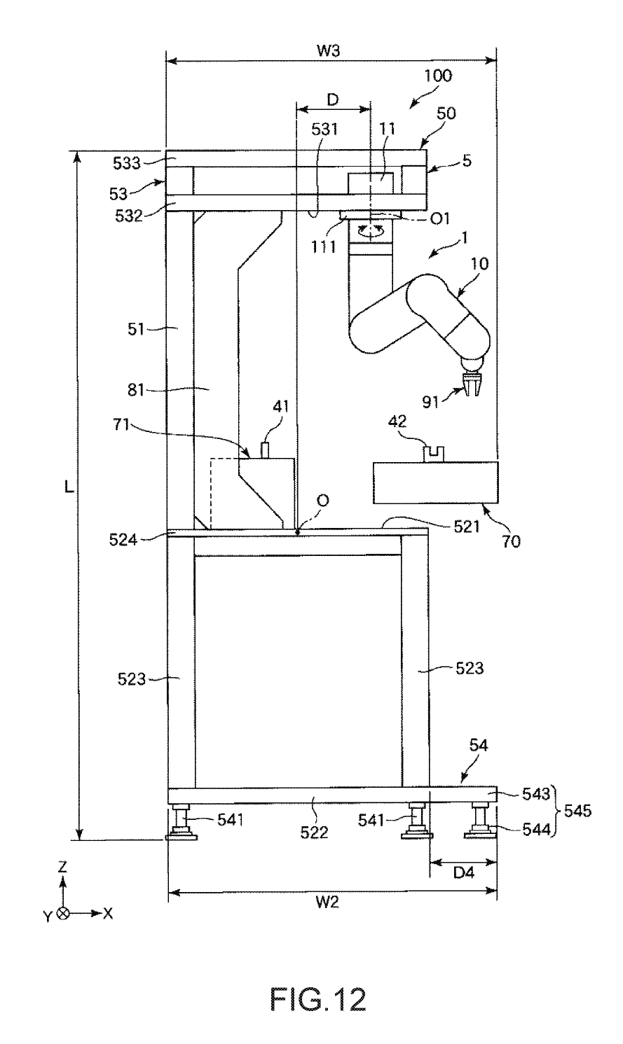

FIG. 11 shows the second embodiment of the robot system according to the invention. FIG. 12 is a side view of the robot system shown in FIG. 11.

As below, the second embodiment will be explained with reference to the drawings and the explanation will be made with focus on differences from the above described embodiment and the explanation of the same items will be omitted.

The robot system of the embodiment is the same as the above described first embodiment except that the configuration of the cell is different.

A cell 5 of a robot system 100 shown in FIG. 11 includes a foot portion 54 having four feet 541 and two projecting portions 545, a workbench 52, two pillars 51, a ceiling portion 53, and two reinforcing plates (reinforcing portions) 81. That is, the cell 5 in the embodiment is different from that of the first embodiment in that the foot portion 54 includes the two projecting portions 545, the two pillars 51 are omitted, and the two reinforcing plates 81 are provided. As below, the foot portion 54, the pillars 51, and the reinforcing plates 81 will be sequentially explained.

### Foot Portion

The foot portion 54 shown in FIGS. 11 and 12 includes the four feet 541 provided below a bottom plate 522 and the two projecting portions 545 projecting from the workbench 52 in the +X-axis direction. Note that, in the embodiment, the number of projecting portions 545 is two, however, any number of projecting portions may be used, not limited that.

The projecting portion 545 includes a projecting piece 543 projecting from the workbench 52 in the +X-axis direction, and a foot 544 projecting downward from an end of the projecting piece 543 at the +X-axis side.

Further, in the embodiment, the projecting portions 545 project in the +X-axis direction by amounts of shift from the center O of the first rotation axis O1. That is, as shown in FIG. 12, a length D4 of the projecting portion 545 in the +X-axis direction is nearly equal to a separation distance D. Thereby, even when the center of gravity of the robot 1 is located at the +X-axis side with respect to the center O, the cell 5 may be supported more stably by the foot portion 54.

Note that, in the embodiment, the length D4 is nearly equal to the separation distance D, or may not necessarily be nearly equal to the separation distance D. The length D4 and the separation distance D preferably satisfy a relationship of 0.5≦D/D4≦2.0, more preferably satisfy a relationship of 0.6≦D/D4≦1.7, and even preferably satisfy a relationship of 0.8≦D/D4≦1.3. Thereby, excessive lengths of the projecting portions 545 may be suppressed and the robot 1 may be supported more stably by the ceiling portion 53.

The specific length of the length D4 is not particularly limited. For example, the length is preferably from 10 mm to 600 mm, more preferably from 20 mm to 500 mm, and even more preferably from 30 mm to 300 mm. Thereby, excessive lengths of the projecting portions 545 may be suppressed, and therefore, the cell 5 may be downsized. Even when the center of gravity of the robot 1 is located at the +X-axis side with respect to the center O, the robot 1 may be supported more stably by the ceiling portion 53, and thus, the robot 1 may be driven more stably.

### Pillars

The cell 5 shown in FIGS. 11 and 12 supports the ceiling portion 53 by the two pillars 51 provided at the −X-axis side on the work surface 521. Further, in the embodiment, the conveyer 70 is provided over the inside and the outside of the cell 5. As described above, the pillars 51 at the +X-axis side on the work surface 521 are omitted and the +X-axis side of the work surface 521 may be opened, and the conveyer 70 may be placed so that a part of the conveyer 70 may overlap with the work surface 521 in the plan view. Thereby, as shown in FIG. 12, a total width (a width in the +X-axis direction) W3 of the conveyer 70 and the robot cell 50 may be made smaller.

Further, the +X-axis side of the work surface 521 is opened, and the distal end of the robot arm 10 may be moved to the outside of the workbench 52 without interference with the pillars 51. Accordingly, the operability of the robot 1 outside of the workbench 52 (outside of the cell 5) may be further improved.

In the embodiment, the part processing portion 72 in the first embodiment is omitted. In this case, incorporation (processing) of the part 41 in the part 42 may be performed on the conveyer 70.

### Reinforcing Plates

The cell 5 shown in FIGS. 11 and 12 includes the two reinforcing plates 81 connected to the work plate 524, the pillars 51, and the top plate 532.

The reinforcing plates 81 are provided at the pillars 51 side and their plate surfaces are placed on the work surface 521 along the vertical direction. Further, the reinforcing plates 81 have widths (widths in the X-axis direction) in the side view gradually increasing toward the ceiling portion 53 near the ceiling portion 53. Furthermore, the reinforcing plates 81 have widths (widths in the X-axis direction) in the side view gradually increasing toward the work plate 524 near the work plate 524. Thereby, the reinforcing plates 81 may be placed on the work surface 521 more stably.

The reinforcing plates 81 may be formed using any members, e.g. steel plates, acrylic plates, or the like. When e.g. acrylic plates are used as the reinforcing plates 81, the acrylic plates are surrounded by a frame body of a metal with relatively high strength, and thereby, the strength of the reinforcing plates 81 may be improved.

The reinforcing plates 81 are provided, and thereby, bending of the ceiling portion 53 downward may be suppressed. Thereby, even when the center of gravity of the robot 1 is located at the +X-axis side with respect to the center O, the robot 1 may be supported more stably by the ceiling portion 53.

Note that the shapes, the placement, and the number of the respective reinforcing plates 81 are not limited to those illustrated, but may be arbitrary. Further, the respective reinforcing plates 81 are not necessarily connected to the work plate 524, the pillars 51, and the ceiling portion 53, and may exert the equal advantages to the above described advantages when provided at least in contact with the pillars 51 and the ceiling portion 53. Furthermore, the reinforcing plates 81 may be detachable or not.

According to the second embodiment, the same advantages as those of the above described first embodiment may be exerted.

### Third Embodiment

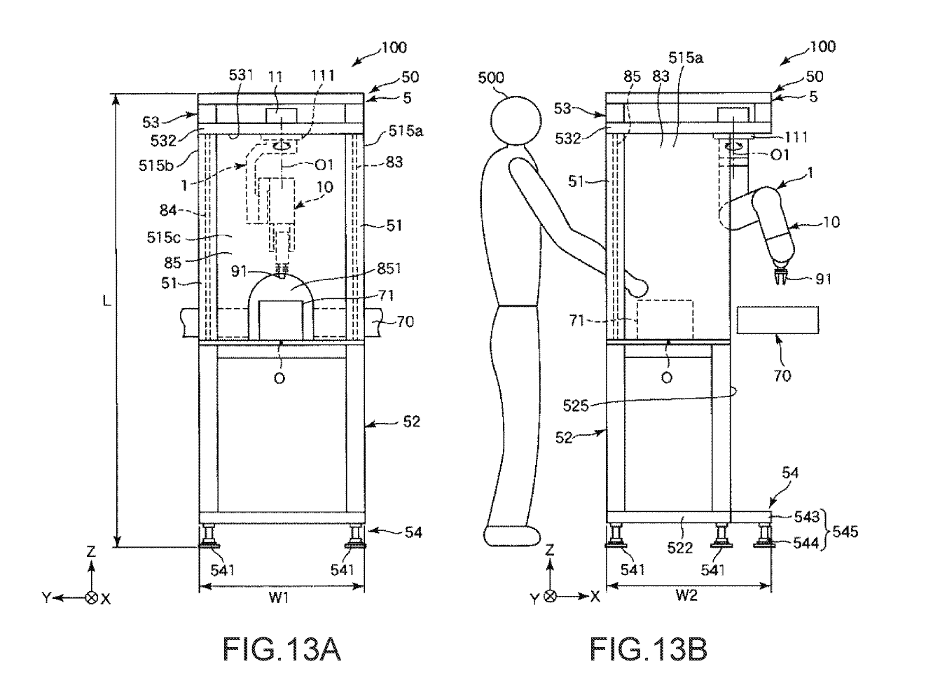

FIGS. 13A and 13B are side views showing the third embodiment of the robot system according to the invention.

As below, the third embodiment will be explained with reference to the drawings and the explanation will be made with focus on differences from the above described embodiments and the explanation of the same items will be omitted.

The robot system of the embodiment is the same as the above described first embodiment except that the configuration of the cell is different.

A cell 5 of a robot system 100 shown in FIGS. 13A and 13B includes a foot portion 54 having four feet 541 and two projecting portions 545, a workbench 52, two pillars 51, a ceiling portion 53 projecting in the +X-axis direction, and three safety plates 83, 84, 85. That is, the cell 5 in the embodiment is different from that of the first embodiment in that the foot portion 54 includes the two projecting portions 545, the two pillars 51 are omitted, the ceiling portion 53 projects in the +X-axis direction, and the three safety plates 83, 84, 85 are provided. Further, the foot portion 54 has the same configuration as that of the foot portion 54 in the above described second embodiment and the pillars 51 are the same as the two pillars 51 in the above described second embodiment.

As below, the ceiling portion 53 and the safety plates 83, 84, 85 will be sequentially explained.

### Ceiling Portion

The cell 5 shown in FIGS. 13A and 13B is formed to have a larger area of the ceiling portion 53 in the plan view than an area of the work surface 521 in the plan view. Further, as shown in FIG. 13B, a part of the ceiling portion 53 is provided to project beyond the workbench 52 in the +X-axis direction. The robot 1 is provided so that the first rotation axis O1 may be located at the +X-axis side with respect to a side surface 525 of the workbench 52 at the +X-axis side (an end surface of the workbench 52 at the conveyer 70 side) in the plan view. The robot 1 is provided as described above, and thereby, the operability of the robot 1 outside of the workbench 52 (outside of the cell 5) may be further improved.

### Safety Plates

The cell 5 shown in FIGS. 13A and 13B includes the safety plates 83, 84, 85.

The safety plate 83 is provided in nearly the entire of a side surface portion 515a at the −Y-axis side as a region surrounded by the pillar 51 located at the −Y-axis side, the ceiling portion 53, and the workbench 52. The safety plate 83 is provided with its plate surface along the vertical direction and connected to the pillar 51, the work surface 521, and the ceiling surface 531.

The safety plate 84 is provided in nearly the entire of a side surface portion 515b at the +Y-axis side as a region surrounded by the pillar 51 located at the +Y-axis side, the ceiling portion 53, and the workbench 52. The safety plate 84 is provided with its plate surface along the vertical direction and connected to the pillar 51, the work surface 521, and the ceiling surface 531.

The safety plate 85 is provided in nearly the entire of a side surface portion 515c at the −X-axis side as a region surrounded by the two pillars 51, the ceiling portion 53, and the workbench 52. The safety plate 85 is provided with its plate surface along the vertical direction and connected to the two pillars 51, the work surface 521, and the ceiling surface 531. Further, an opening 851 for communication between the inside and the outside of the cell 5 is provided in the lower part of the safety plate 85. The opening 851 is provided, and thereby, a human (worker) 500 may supply parts to a part supply portion 71 within the cell 5 and easily check the status within the cell 5. Note that, in the embodiment, the opening 851 is provided in the safety plate 85, however, an openable door portion (window portion) may be provided in place of the opening 851.

The safety plates 83, 84, 85 are provided, and thereby, unintended entrance of e.g. the worker 500 or foreign matter including dust into the space above the work surface 521 of the cell 5 may be prevented. Further, the safety plates 83, 84, 85 may also exert a function as reinforcing plates supporting the ceiling portion 53.

The safety plates 83, 84, 85 may be formed using any members, and preferably using e.g. steel plates or the like. Thereby, the rigidity of the safety plates 83, 84, 85 may be improved and a function of preventing entrance of e.g. the worker 500 or foreign matter and a function as reinforcing portions may be improved. Or, the safety plates 83, 84, 85 are formed using members having light-transmissivity such as acrylic plates, and thereby, visual recognition of the space above the work surface 521 may be improved.

Note that the shapes, the placement, and the number of the respective safety plates 83, 84, 85 are not limited to those illustrated, but may be arbitrary. Further, the safety plate 83 is not necessarily provided in nearly the entire of the side surface portion 515a, but may be provided in a part of the side surface portion 515a. The same applies to the safety plates 84, 85. The respective safety plates 83, 84, 85 may be detachable or not.

According to the third embodiment, the same advantages as those of the above described first embodiment may be exerted.

### Fourth Embodiment

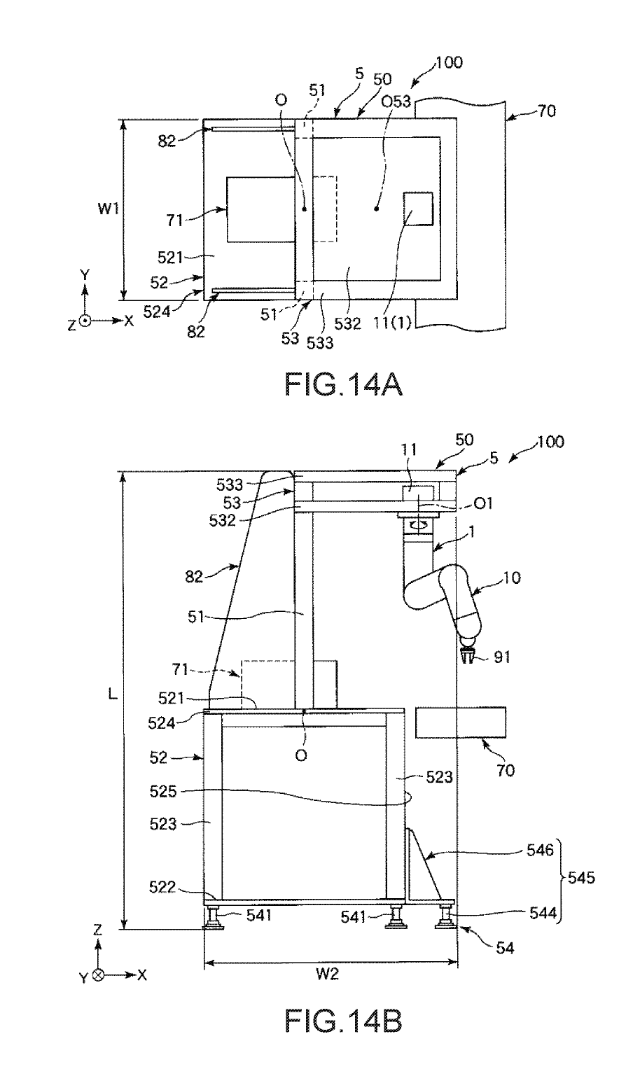

FIGS. 14A and 14B show the fourth embodiment of the robot system according to the invention. FIG. 14A is a top view and FIG. 14B is a side view.

As below, the fourth embodiment will be explained with reference to the drawings and the explanation will be made with focus on differences from the above described embodiments and the explanation of the same items will be omitted.

The robot system of the embodiment is the same as the above described first embodiment except that the configuration of the cell is different.

A cell 5 of a robot system 100 shown in FIGS. 14A and 14B includes a foot portion 54 having four feet 541 and two projecting portions 545, a workbench 52, two pillars 51 provided in the center part of the work surface 521 in the X-axis direction, a ceiling portion 53, and two reinforcing plates 82. That is, the cell 5 in the embodiment is different from that of the first embodiment in that the foot portion 54 includes the two projecting portions 545, the two pillars 51 are omitted and the other two pillars 51 are provided in the center part in the X-axis direction, and the two reinforcing plates 82 are provided.

As below, the foot portion 54, the pillars 51, and the reinforcing plates 82 will be sequentially explained.

### Foot Portion

The foot portion 54 of the cell 5 shown in FIGS. 14A and 14B includes the four feet 541 provided below a bottom plate 522 and the two projecting portions 545 projecting from the workbench 52 in the +X-axis direction. Note that the two projecting portions 545 are provided on a side surface (end surface) of the workbench 52 at the +X-axis side. Further, in the embodiment, the number of projecting portions 545 is two, however, any number of projecting portions may be used, not limited that.

The projecting portion 545 includes a bracket (support) 546 projecting from the workbench 52 in the +X-axis direction and having a triangular shape as seen from the Y-axis direction, and a foot 544 projecting downward from an end of the bracket 546 at the +X-axis side. The projecting portions 545 are provided, and thereby, even when the center of gravity of the robot 1 is located at the +X-axis side with respect to the center O, the cell 5 may be supported more stably by the foot portion 54.

Further, the projecting portions 545 are detachably attached to the workbench 52. Thereby, for example, the projecting portions 545 may be changed according to the amounts of shift from the center O of the first rotation axis O1. Accordingly, even when the position of the first rotation axis O1 is changed, the cell 5 may be supported more stably by the foot portion 54.

### Pillars

In the cell 5 shown in FIGS. 14A and 14B, as described above, the two pillars 51 are provided in the center part of the work surface 521 in the X-axis direction. Further, the robot 1 is provided so that the first rotation axis O1 may be located at the +X-axis side with respect to the side surface (end surface) 525 of the workbench 52 on the +X-axis side. Furthermore, the robot 1 is provided so that the first rotation axis O1 may be located at the +X-axis side with respect to a center O53 of a ceiling surface 531 in the plan view. The robot 1 is provided as described above, and thereby, the operability of the robot 1 outside of the cell 5 may be further improved.

In the embodiment, the positions of the pillars 51 with respect to the workbench 52 can be changed in the X-axis direction. Thereby, the positions of the pillars 51 are changed according to e.g. the work of the robot 1 or the like, and therefore, the operability of the robot 1 on the workbench 52 or outside of the workbench 52 (the inside and the outside of the cell 5) may be further improved.

A configuration for changing the positions of the pillars 51 includes e.g. a configuration in which a plurality of concave portions (not shown) corresponding to the shapes of the ends of the pillars 51 are formed in the edge portion of the work plate 524 for changing the positions of the pillars 51 by inserting the pillars 51 into the concave portions in desired locations. Or, for example, a groove (not shown) may be formed in the edge portion of the work plate 524 and the pillars 51 may be provided movably along the groove. According to these configurations, the positions of the pillars 51 may be changed more easily. The configuration for changing the positions of the pillars 51 may be any configuration as long as the configuration can change the positions of the pillars 51 with respect to the workbench 52.

Further, the movement direction of the pillars 51 may be arbitrary, not limited to the X-axis direction. For example, the pillars may be movable in the Y-axis direction.

### Reinforcing Plates

The cell 5 shown in FIGS. 14A and 14B includes the two reinforcing plates (reinforcing portions) 82 connected to the work plate 524, the pillars 51, and the ceiling portion 53.

The reinforcing plates 82 are provided on the −X-axis side of the pillars 51, i.e., an opposite side to the side with the conveyer 70 provided thereon of the pillars 51. The reinforcing plates 82 are provided on the work surface 521 with their plate surfaces along the vertical direction. Further, the heights of the reinforcing plates 82 (lengths in the vertical direction) are nearly equal to a separation distance between the work surface 521 and the upper surface of the cell 5 (an upper surface of an upper frame 533). The widths of the reinforcing plates 82 (widths in the X direction) in the side view gradually increase toward the work plate 524. Thereby, the reinforcing plates 82 may be placed on the work surface 521 more stably. Note that, in the embodiment, the heights of the reinforcing plates 82 are nearly equal to the separation distance between the work surface 521 and the upper surface of the cell 5, however, the heights of the reinforcing plates 82 are not limited to those. It is preferable that the heights of the reinforcing plates 82 are equal to or more than the separation distance between the work surface 521 and the ceiling surface 531. Thereby, the robot 1 may be supported more stably by the ceiling portion 53.

The reinforcing plates 82 may be formed using any members, e.g. steel plates, acrylic plates, or the like.

The reinforcing plates 82 are provided, and thereby, the rigidity of the pillars 51 may be improved, and therefore, the ceiling portion 53 may be supported by the pillars 51 more strongly. Accordingly, bending of the ceiling portion 53 downward may be suppressed, and the robot 1 may be supported more stably by the ceiling portion 53.

Note that the shapes, the placement, and the number of the respective reinforcing plates 82 are not limited to those illustrated, but may be arbitrary. Further, the reinforcing plates 82 may be detachable or not.

According to the fourth embodiment, the same advantages as those of the above described first embodiment may be exerted.

### Fifth Embodiment

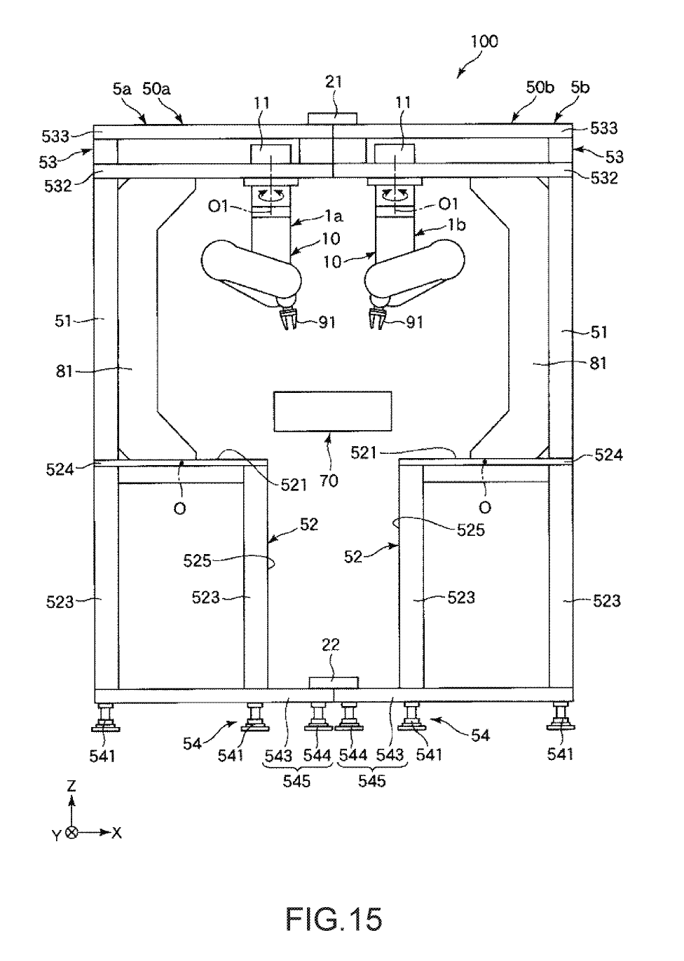

FIG. 15 is a side view showing the fifth embodiment of the robot system according to the invention. In the above described embodiments, the +X-axis direction is referred to as the first direction, however, in the embodiment, the +X-axis direction in a robot cell on the left in FIG. 15 is referred to as “first direction” and the −X-axis direction in a robot cell on the right in FIG. 15 is referred to as “first direction”.

As below, the fifth embodiment will be explained with reference to the drawings and the explanation will be made with focus on differences from the above described embodiments and the explanation of the same items will be omitted.

The robot system of the embodiment is mainly the same as the above described first embodiment except that two robot cells are provided.

A robot system 100 shown in FIG. 15 includes a robot cell 50a (first robot cell) and a robot cell 50b (second robot cell).

The robot cell 50a includes a robot 1a (first robot) with a robot arm 10 and a cell 5a (first cell). Further, the robot cell 50b includes a robot 1b (second robot) with a robot arm 10 and a cell 5b (second cell). The robot cells 50a, 50b have the same configuration as the robot cell 50 in the above described third embodiment except that the respective robot cells do not include safety plates 83, 84, 85, but include reinforcing plates 81 instead.

The cell 5a and the cell 5b are provided so that side surfaces 525 of workbenches 52 on which the pillars 51 are not provided may face each other. That is, the cell 5a and the cell 5b are provided so that the robot 1a and the robot 1b may be close to each other.

Further, the cell 5a and the cell 5b are coupled by coupling plates (coupling portions) 21, 22.

The coupling plate 21 is provided in the upper part of ceiling portions 53, and couples an upper frame 533 of the cell 5a and an upper frame 533 of the cell 5b. Further, the coupling plate 22 is provided in the lower part of the workbenches 52, and couples a projecting piece 543 of a foot portion 54 of the cell 5a and a projecting piece 543 of a foot portion 54 of the cell 5b. Note that the fixing method of the coupling plates 21, 22 to the cells 5a, 5b is not particularly limited, but e.g. a fixing method using a plurality of bolts or the like may be employed.

A conveyer 70 is placed between the cell 5a and the cell 5b. The conveyer 70 is provided in a position such that the robot 1a and the robot 1b may perform work.

The conveyer 70 is placed within a space surrounded by the cell 5a and the cell 5b, and thereby, the robot 1a and the robot 1b may cooperatively perform work on e.g. one part on the conveyer 70. Further, as described above, the cells 5a, 5b are provided so that the side surfaces 525 of the workbenches 52 may face each other, and thereby, work may be performed on one part from two directions by the robot 1a and the robot 1b. Accordingly, the work may be performed more efficiently, and the productivity of finally obtained products may be further improved.

Note that the robot 1a and the robot 1b may perform work on the same part mounted on the conveyer 70 or respectively perform work on e.g. different parts mounted on the conveyer 70. Further, the robot 1a and the robot 1b may simultaneously perform work, or, for example, one of the robot 1a and the robot 1b may perform work, and then, the other may perform work.

In the embodiment, the cell 5a and the cell 5b are in contact with each other, however, they may be not in contact, but separated and coupled by the coupling plates 21, 22. Further, in the embodiment, the coupling plate 21 is provided on the respective ceiling portions 53 of the cell 5a and the cell 5b and the coupling plate 22 is provided on the respective foot portions 54 of the cell 5a and the cell 5b, however, the attachment locations of the coupling plates (coupling portions) to the cell 5a and the cell 5b are not limited to those. For example, the coupling plates (coupling portions) may be provided on the respective workbenches 52 of the cell 5a and the cell 5b. Furthermore, the number of coupling plates (coupling portions) may be arbitrary.

According to the fifth embodiment, the same advantages as those of the above described first embodiment may be exerted.

### Sixth Embodiment

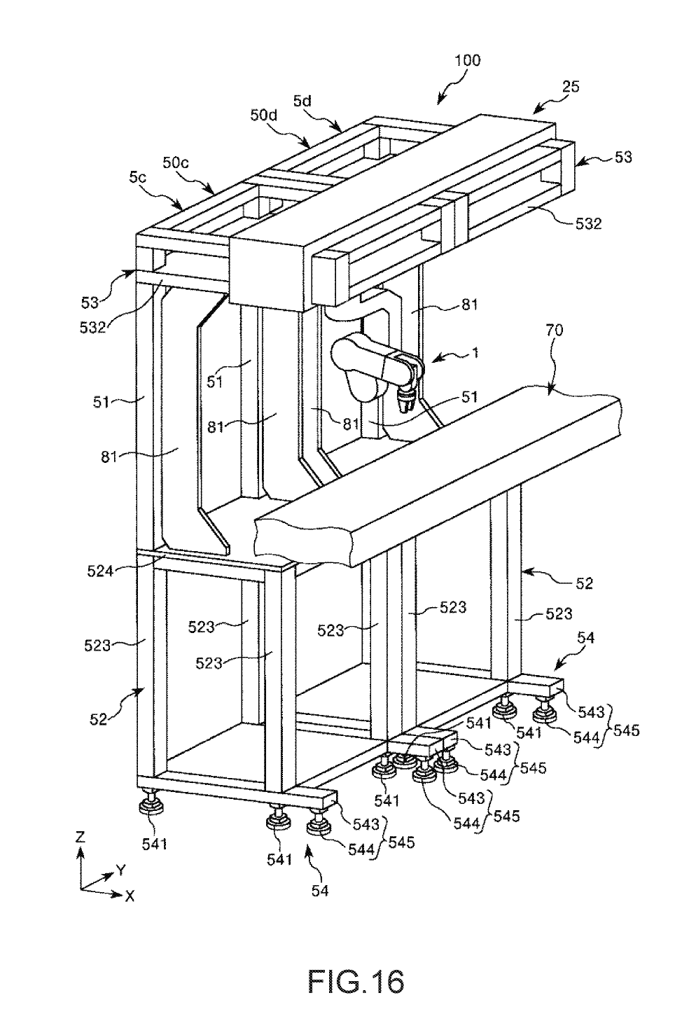

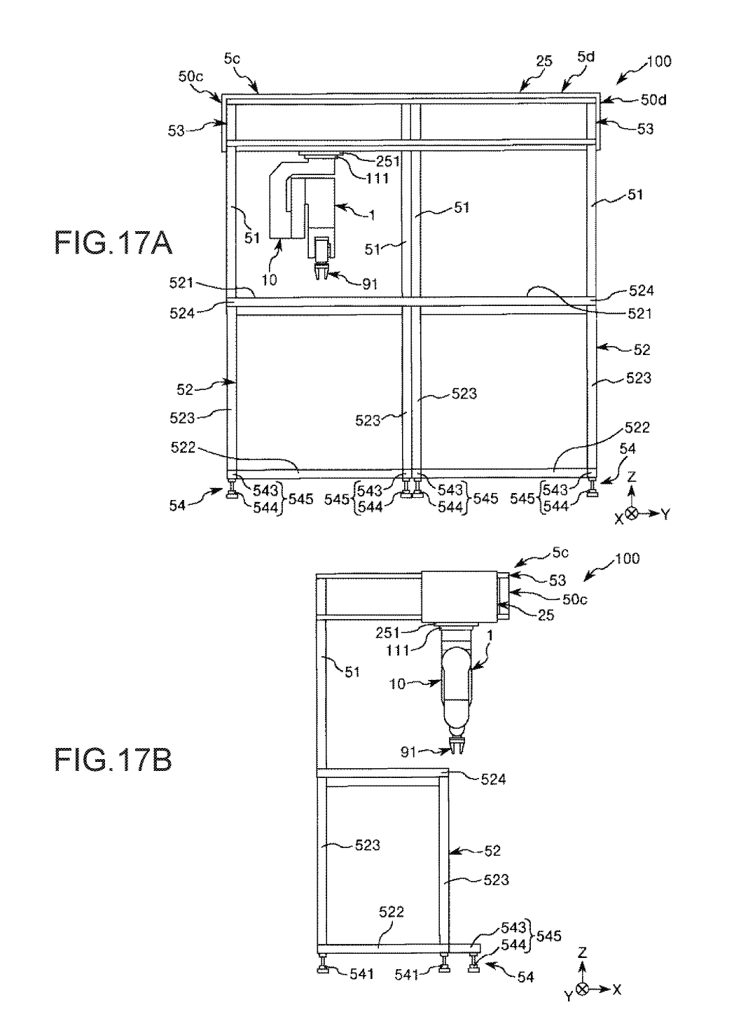

FIG. 16 shows the sixth embodiment of the robot system according to the invention. FIGS. 17A and 17B are side views of the robot system shown in FIG. 16.

As below, the sixth embodiment will be explained with reference to the drawings and the explanation will be made with focus on differences from the above described embodiments and the explanation of the same items will be omitted.

The robot system of the embodiment is mainly the same as the above described embodiments except that two cells are provided and one robot is movable between the two cells.

A robot system 100 shown in FIG. 16 includes a cell 5c (first cell) and a cell 5d (second cell), and a robot (first robot) 1. The cells 5c, 5d have the same configuration as the cell 5 in the above described third embodiment except that the respective cells do not include safety plates 83, 84, 85, but include reinforcing plates 81 instead.

The cell 5c and the cell 5d each include a foot portion 54 having four feet 541 and two projecting portions 545, a workbench 52, four pillars 51, and a ceiling portion 53. These cell 5c and cell 5d are provided so that the pillars 51 may be located nearly on a straight line in the plan view.

On the respective ceiling portions 53 of the cells 5c, 5d, a moving mechanism 25 is provided to cross the ceiling portions 53, and the cells 5c, 5d are coupled by the moving mechanism 25. Further, as shown in FIGS. 17A and 17B, a supporting plate (supporting portion) 251 is provided in the moving mechanism 25, and a base 11 (flange 111) of the robot 1 is attached to the supporting plate 251. The supporting plate 251 is supported by the moving mechanism 25 to reciprocate in the direction in which the cells 5c, 5d are arranged (Y-axis direction). Accordingly, the robot 1 can reciprocate between the cell 5c and the cell 5d.

In this manner, the single robot 1 can reciprocate between the cell 5c and the cell 5d, and thereby, both work within the cell 5a and work within the cell 5b may be performed by the single robot 1 without preparation of two robots. Therefore, the operability of the robot 1 may be further improved.

Note that, though not illustrated, the moving mechanism 25 includes a drive source that generates power for moving the supporting plate 251 and a power transmission mechanism that transmits the power of the drive source to the supporting plate 251. Further, the robot system 100 includes a movement control unit (not shown) that drives the moving mechanism 25.

According to the fifth embodiment, the same advantages as those of the above described first embodiment may be exerted.

### Manufacturing Line

Next, an example of a manufacturing line to which the robot system according to the invention is applied will be explained. Hereinafter, the manufacturing line to which the robot system according to the invention is applied is not limited to the following example.

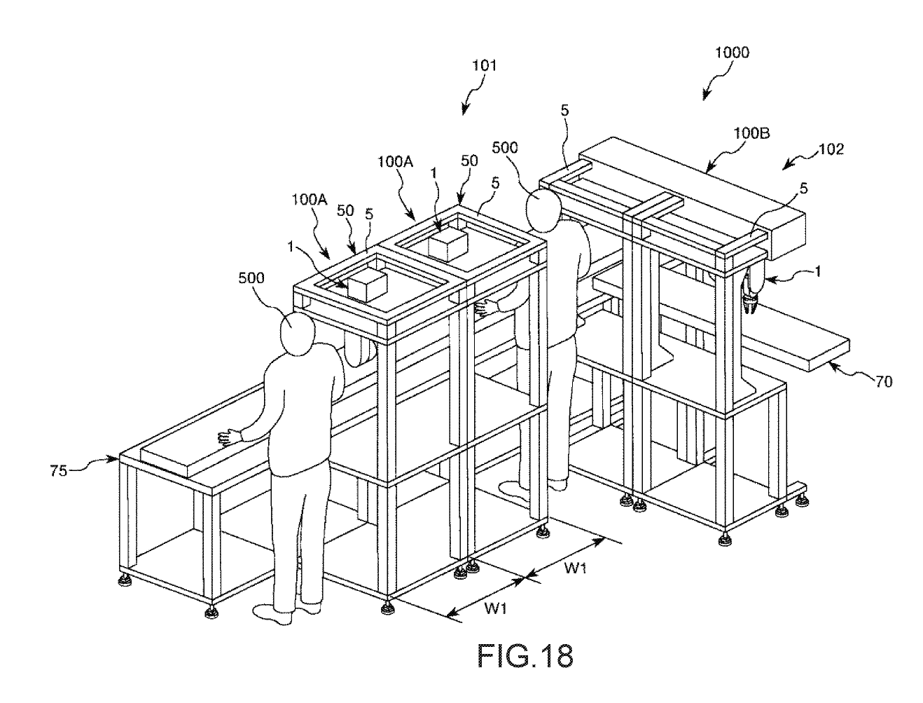

FIG. 18 shows the example of the manufacturing line using the robot system according to the invention. As below, the manufacturing line will be explained with reference to the drawing, and the explanation will be made with focus on differences from the above described robot systems and the explanation of the same items will be omitted.

In a manufacturing line 1000 shown in FIG. 18, workers (humans) 500 and robot systems 100A, 100B coexist around a conveyer with support 75 that carries parts (not shown).

The manufacturing line 1000 mainly includes a main line 101 for carrying parts or the like and a sub-line 102 for incorporation of parts, inspection of parts, etc.

The main line 101 includes the conveyer with support 75 that carries parts (not shown) or the like, and two robot systems 100A that perform incorporation work of parts on the conveyer with support 75. Note that the robot systems 100A have the same configuration as that of the robot system 100 in the first embodiment. In the main line 101, the workers 500 are placed.

The sub-line 102 is connected to the main line 101. The sub-line 102 includes the robot system 100B. The robot system 100B has the same configuration as that of the robot system 100 in the sixth embodiment.

In the manufacturing line 1000, in the main line 101, the workers 500 and robots 1 of the robot systems 100A perform work of feeding, removing, assembly, etc. of the parts. In the sub-line 102, a robot 1 of the robot system 100B performs work of processing etc. of the parts carried from the conveyer with support 75 to a conveyer 70. After the work of processing etc. by the robot 1 of the robot system 100B ends, the parts are carried from the conveyer 70 to the conveyer with support 75 again, and the parts return to the main line 101.

In the manufacturing line 1000, as described above in the first embodiment, the width W1 of the cell 5 of the robot system 100A is nearly equal to or less than the size of the work area in which the worker 500 works, and the work 500 may be easily replaced by the robot cell 50 of the robot system 100A. Note that the reverse change to the above described change, i.e., replacement of the robot cell 50 of the robot system 100A by the worker 500 may be easily made.

As described above, the exchange between the worker 500 and the robot cell 50 of the robot system 100A may be easily performed, and thereby, the manufacturing line 1000 may be easily changed without major change of changing the placement of the conveyer with support 75 or the like. Further, even when the workers 500 are replaced by the robot cells 50 of the robot systems 100A, increase in the length of the manufacturing line 1000 may be suppressed.

As above, the robot system according to the invention and the manufacturing line using the system are explained according to the illustrated embodiments, however, the invention is not limited to those and the configurations of the respective parts may be replaced by arbitrary configurations having the same functions. Further, other arbitrary configurations may be added. Furthermore, the invention may include a combination of two or more arbitrary configurations (features) of the above described respective embodiments.

In the above described embodiments, the number of rotation axes of the robot arm of the robot is six, however, the invention is not limited to that. The number of rotation axes of the robot arm may be e.g. two, three, four, five, or seven or more. Further, in the above described embodiments, the number of arms of the robot is six, however, the invention is not limited to that. The number of arms of the robot may be e.g. two, three, four, five, or seven or more.

In the above described embodiments, the number of robot arms of the robot is one, however, the invention is not limited to that. The number of robot arms of the robot may be e.g. two or more. That is, the robot may be e.g. a multi-arm robot including a dual-arm robot.

In the above described fifth embodiment and sixth embodiment, the form in which the two cells are coupled is explained, however, the number of coupled cells is not limited that, but may be two or more.

Further, in the above described embodiments, the attachment surface as the location to which the base of the robot is fixed is the ceiling surface, however, the attachment surface is not limited to that. The attachment surface may be e.g. the upper surface of the ceiling portion, the pillars, the work surface, or the like.

Furthermore, in the above described embodiments, the vertical articulated robot is taken as an example for explanation, however, the robot of the robot system according to the invention is not limited to that. For example, the robot may be a robot having any configuration including a horizontal articulated robot.

In the above described embodiments, the cell includes feet, however, may have no foot. In this case, the bottom plate located on the lower end of the workbench may be directly installed in the installation space. When the bottom plate is directly installed in the installation space, the bottom plate may be regarded as a foot portion by which the entire cell is installed in the installation space. Further, the configuration of the foot portion is not limited to the configurations of the above described embodiments, but may be any configuration as long as the cell may be installed in the installation space.

In the above described first embodiment, the foot portion is attached to the bottom part of the workbench, however, the attachment position of the foot portion is not limited to that. For example, the foot portion may be attached to a side of the workbench.

In the above described embodiments, the conveyer is separated from the robot system, however, the robot system may include a conveyer (carrying unit).

Further, in the above described embodiments, the first robot is attached to the ceiling portion (attachment portion), however, the first robot may be movably provided to the ceiling portion (attachment portion) as long as the first rotation axis can be provided at the +X-axis side with respect to the center of the work surface in the plan view. The same applies to the second robot.

The entire disclosure of Japanese Patent Application No. 2015-091212, filed Apr. 28, 2015 is expressly incorporated by reference herein.

What is claimed is:

1. A robot system comprising:
a first robot having a robot arm including a first arm rotatable about a first rotation axis at the most proximal end; and
a movable first cell,
wherein the first cell includes
a bench portion,
a pillar provided on the base portion, and
an attachment portion provided on the pillar, on which the first robot is provided,
the first rotation axis can be placed in a position shifted in a first direction from an intermediate position of a length of the bench portion in the first direction, and
at least a part of the robot arm is movable to an outside of the bench portion in a plan view by moving in the first direction.

2. The robot system according to claim 1, wherein the first robot includes a second arm provided on the first arm rotatably about a second rotation axis in an axis direction different from an axis direction of the first rotation axis,
a length of the first arm is longer than a length of the second arm, and
the first arm and the second arm can overlap as seen from the second rotation axis.

3. The robot system according to claim 1, wherein the first cell includes a foot portion provided on the bench portion for installation of the first cell in a predetermined installation location, and
the foot portion includes a projecting portion projecting from the bench portion in the first direction.

4. The robot system according to claim 3, wherein a length of the projecting portion in the first direction is from 10 mm to 600 mm.

5. The robot system according to claim 3, wherein the projecting portion is detachably attached to the bench portion.

6. The robot system according to claim 1, wherein at least a part of a carrying unit that carries parts is placed inside the first cell.

7. The robot system according to claim 1, wherein the first cell includes a reinforcing portion provided on the pillar and the attachment portion.

8. The robot system according to claim 1, wherein the first rotation axis is located outside of the bench portion in the plan view.

9. The robot system according to claim 1, wherein a connecting position of the pillar to the bench portion is provided in a position different from an end of the bench portion.

10. The robot system according to claim 1, wherein a position of the pillar with respect to the bench portion is changeable.

11. The robot system according to claim 1, further comprising a second cell,
wherein the first cell and the second cell are coupled.

12. The robot system according to claim 11, wherein a second robot having a robot arm is provided in the second cell.

13. The robot system according to claim 11, wherein at least a part of a carrying unit that carries parts is placed between the first cell and the second cell.

14. The robot system according to claim 11, further comprising a supporting portion provided movably with respect to the attachment portion and supporting the first robot,
wherein the supporting portion is provided movably from the first cell to the second cell.

15. A robot system comprising:
a first robot having a robot arm including a first arm rotatable about a first rotation axis at the most proximal end; and
a movable first cell,
wherein the first cell includes
a bench portion,
a pillar provided on the base portion, and
an attachment portion provided on the pillar, on which the first robot is provided,
an attachment position of the first robot with respect to the attachment portion can be placed in a position shifted in a first direction from an intermediate position of a length of the bench portion in the first direction, and
at least a part of the robot arm is movable to an outside of the bench portion in a plan view by moving in the first direction.
